(19) United States
(12) Patent Application Publication
(10) Pub. No.: US 2024/0376993 A1
(43) Pub. Date: Nov. 14, 2024

(54) Reversing Valve

(71) Applicant: ZHEJIANG DUNAN ARTIFICIAL ENVIRONMENT CO., LTD., Shaoxing, Zhejiang (CN)

(72) Inventors: Bin CAI, Shaoxing, Zhejiang (CN); Fan FENG, Shaoxing, Zhejiang (CN)

(21) Appl. No.: 18/696,067

(22) PCT Filed: Sep. 19, 2022
(86) PCT No.: PCT/CN2022/119670

§ 371 Date: Mar. 27, 2024

(30) Foreign Application Priority Data
Sep. 28, 2021 (CN) 202122382555.5

(51) Int. Cl. F16K 27/10; F16K 27/12; F25B 41/26

(52) U.S. Cl. CPC F16K 27/107; F16K 27/12; F25B 41/26

(57) ABSTRACT

The present disclosure provides a reversing valve, including a valve body, an end cover and a welding groove, an end portion of the valve body is a connecting end; the end cover includes a cover body, a cone, and a cylinder, an end with a small outer diameter of the cone is connected with the cover body, an end with a large outer diameter of the cone is connected with the cylinder, both the cone and the cylinder are inserted into the connecting end; and the welding groove includes a first groove section and a second groove section that are mutually communicated, the first groove section is located between the outer wall of the cone and the inner wall of the connecting end, and the second groove section is located between the outer wall of the cylinder and the inner wall of the connecting end.

### CROSS-REFERENCE TO RELATED APPLICATION

The present disclosure is a national stage application of International Patent Application No. PCT/CN2022/119670, which is filed on Sep. 19, 2022, and claims priority to Chinese Patent Application No. 202122382555.5, filed on Sep. 28, 2021 and entitled “Reversing Valve”, the contents of which are hereby incorporated by reference in its entirety.

### TECHNICAL FIELD

The present disclosure relates to the technical field of valves, in particular to a reversing valve.

### BACKGROUND

In heat pump air conditioners, a four-way reversing valve is a key component for converting refrigeration cycle state and heating cycle state of a system. By switching the four-way reversing valve, the mutual conversion between refrigeration and heating can be achieved. The four-way reversing valve mainly consists of an electromagnetic coil, a pilot valve, and a main valve. The main valve switches a flow direction of a refrigerant under the combined action of the electromagnetic coil and the pilot valve, to achieve the mutual conversion between refrigeration and heating of the air conditioning.

Herein, the main valve of the four-way reversing valve is composed of a valve body, an end cover, a piston and other structures. The end cover is welded to the valve body by means of welding, to achieve sealing at both ends of the valve body. In existing technologies, the end cover is closely fitted to a cavity of the valve body, and there is no gap between the end cover and the valve body. A solder generated during the welding could not penetrate into a close-fitting area, so that the welding quality between the end cover and the inner wall of the valve body is poor, and thus a problem of valve body leakage is easily produced.

### SUMMARY

Some embodiments of the present disclosure provide a reversing valve, as to solve a problem of poor welding quality between an end cover and an inner wall of a valve body in existing technologies.

In order to solve the above problem, some embodiments of the present disclosure provide a reversing valve, where the reversing valve includes a valve body, an end cover, and a welding groove, herein the valve body is a tubular structure, and an end portion of the valve body is a connecting end; the end cover includes a cover body, a cone, and a cylinder, an end with a small outer diameter of the cone is connected with the cover body, an end with a large outer diameter of the cone is connected with the cylinder, both the cone and the cylinder are inserted into the connecting end, and an outer wall of the cone and an outer wall of the cylinder are both welded with an inner wall of the connecting end; and the welding groove is used for filling a solder, the welding groove includes a first groove section and a second groove section that are mutually communicated, the first groove section is located between the outer wall of the cone and the inner wall of the connecting end, and the second groove section is located between the outer wall of the cylinder and the inner wall of the connecting end.

In some embodiments, the first groove section is located on the outer wall of the cone, and/or the second groove section is located on the outer wall of the cylinder.

In some embodiments, the first groove section extends along a busbar on an outer surface of the cone, and the second groove section extends along an axis of the cylinder.

In some embodiments, a length of the first groove section is equal to a length of the busbar on the outer surface of the cone, or a length of the first groove section is less than a length of the busbar on the outer surface of the cone.

In some embodiments, a length of the second groove section is equal to an axial length of the cylinder, or a length of the second groove section is less than an axial length of the cylinder.

In some embodiments, a groove depth of the welding groove on a radial section of the welding groove is 0.02 mm to 0.1 mm.

In some embodiments, the inner wall of the connecting end includes a cylindrical wall and a conical wall that are mutually connected, herein the cylindrical wall is welded with the cylinder, and the conical wall is welded with the cone.

In some embodiments, the first groove section is located on the conical wall, and the second groove section is located on the cylindrical wall.

In some embodiments, there is a plurality of the welding grooves, and the plurality of the welding grooves is disposed along a circumferential direction of the end cover.

In some embodiments, a connection portion between the outer wall of the cone and the outer wall of the cylinder has a chamfer, and the plurality of the welding grooves is formed by a knurling structure.

In some embodiments, a size of the cover body is less than a size of the cone in a radial direction of the valve body; and a length of the connecting end is greater than a total length of the cone and the cylinder in an axial direction of the valve body.

In some embodiments, one end of the first groove section is communicated with an outside of the reversing valve.

In some embodiments, a cross-section of the welding groove is rectangular or semi-circular.

In some embodiments, the valve body includes a main body and the connecting end, a wall thickness of the connecting end is less than a wall thickness of the main body, the cylinder is abutted against the main body.

In some embodiments, the connecting end includes an outer peripheral surface and a limiting surface, the limiting surface is stop matched with the end cover.

In some embodiments, there are two end covers and two connecting ends.

In some embodiments, the reversing valve is a four-way valve.

By applying technical schemes of the present disclosure, a reversing valve is provided, including a valve body, an end cover 20 and a welding groove 30, herein the valve body is a tubular structure, and an end portion of the valve body is a connecting end; the end cover includes a cover body, a cone, and a cylinder, an end with a small outer diameter of the cone is connected with the cover body, an end with a large outer diameter of the cone is connected with the cylinder, both the cone and the cylinder are inserted into the connecting end, and an outer wall of the cone and an outer wall of the cylinder are both welded with an inner wall of the connecting end; and the welding groove is used for filling a solder, the welding groove includes a first groove section and a second groove section that are mutually communicated, the first groove section is located between the outer wall of the cone and the inner wall of the connecting end, and the second groove section is located between the outer wall of the cylinder and the inner wall of the connecting end. By adopting this scheme, the first groove section is disposed between the outer wall of the cone and the inner wall of the connecting end, and the second groove section is disposed between the outer wall of the cylinder and the inner wall of the connecting end, and the first groove section and the second groove section are mutually communicated, which can make the solder more easily penetrate into the first groove section and the second groove section during the welding of the outer wall of the cone, the outer wall of the cylinder, and the inner wall of the connecting end, and the welding groove can be fully filled with the solder, thereby a problem that the solder could not be penetrated during the welding due to the close-fitting between the end cover and the valve body can be avoided. Herein, the disposition of the cone of the end cover can facilitate the solder to flow into the first groove section and the second groove section during the welding, and the welding quality and sealing effect between the end cover and the valve body are improved, thereby the valve body is avoided from leaking.

### BRIEF DESCRIPTION OF THE DRAWINGS

Drawings of the description for constituting a part of the present disclosure are used to provide further understanding of the present disclosure, and schematic embodiments of the present disclosure and descriptions thereof are used to explain the present disclosure and do not constitute improper limitations on the present disclosure. In the drawings:

FIG. 1 illustrates a structure diagram of a reversing valve provided in an embodiment of the present disclosure;

FIG. 2 illustrates a partially enlarged diagram in FIG. 1;

FIG. 3 illustrates a section view of an end cover in FIG. 1;

FIG. 4 illustrates a top view of the end cover in FIG. 3; and

FIG. 5 illustrates a section view of another structure of the end cover in FIG. 1.

Herein, the above drawings include the following drawing reference signs:

10. Valve body; 11. Connecting end; 111. Cylindrical wall; 112. Conical wall;

20. End cover; 21. Cover body; 22. Cone; 23. Cylinder;

30. Welding groove; 31. First groove section; 32. Second groove section.

### DETAILED DESCRIPTION OF THE EMBODIMENTS

Technical schemes in embodiments of the present disclosure are clearly and completely described below in combination with drawings in the embodiments of the present disclosure. Apparently, the embodiments described are only a part of the embodiments of the present disclosure, not all of the embodiments. The following description of at least one exemplary embodiment is only for a descriptive purpose actually and shall not be construed as any limitations on the present disclosure or its applications or uses. Based on the embodiments in the present disclosure, all other embodiments obtained by those of ordinary skill in the art without creative labor shall fall within the scope of protection of the present disclosure.

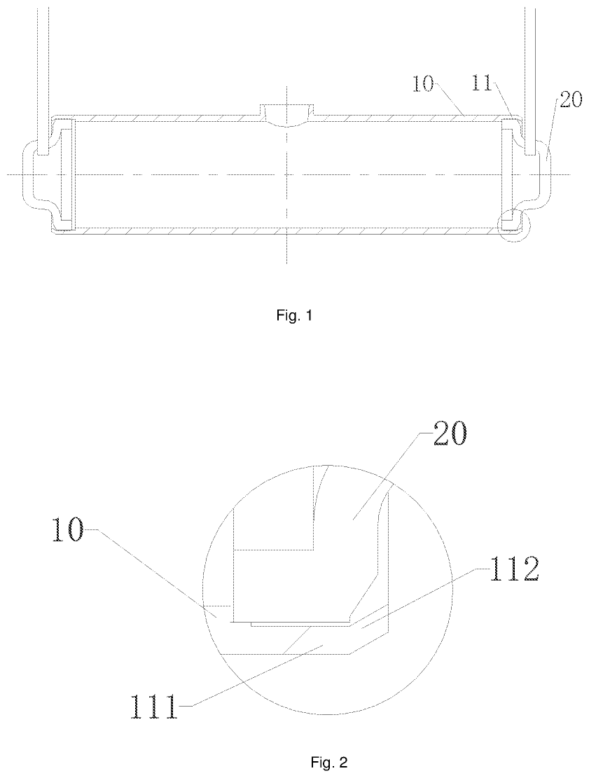

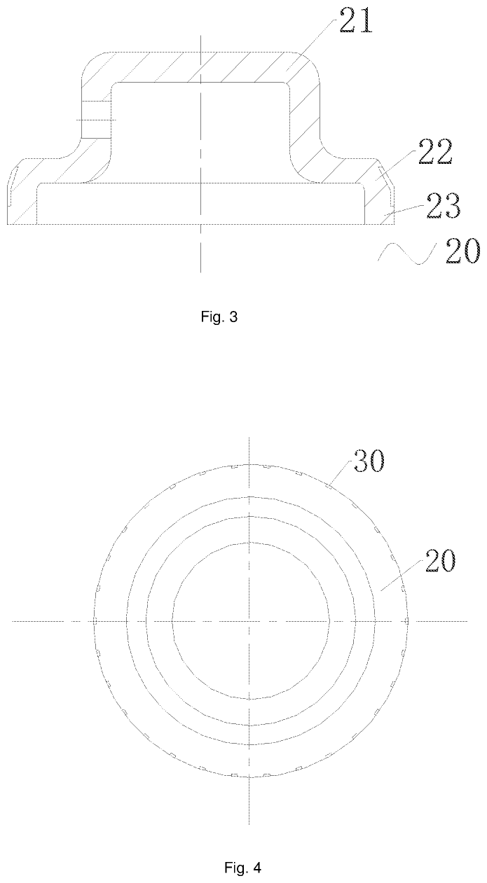

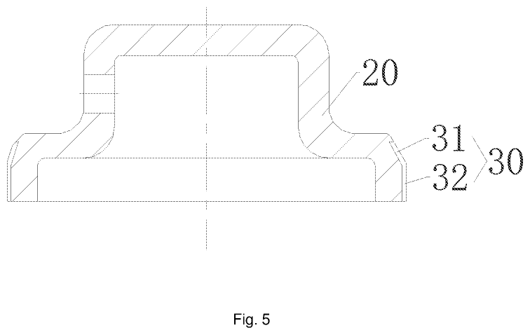

As shown in FIGS. 1 to 5, an embodiment of the present disclosure provides a reversing valve, the reversing valve includes a valve body 10, an end cover 20 and a welding groove 30, herein the valve body 10 is a tubular structure, and an end portion of the valve body 10 is a connecting end 11; the end cover 20 includes a cover body 21, a cone 22, and a cylinder 23, the cone 22 has an end with a small outer diameter and an end with a large outer diameter, the end with a small outer diameter of the cone 22 is connected with the cover body 21, the end with a large outer diameter of the cone 22 is connected with the cylinder 23, both the cone 22 and the cylinder 23 are inserted into the connecting end 11, and an outer wall of the cone 22 and an outer wall of the cylinder 23 are both welded with an inner wall of the connecting end 11; and the welding groove 30 is used for filling a solder, the welding groove 30 includes a first groove section 31 and a second groove section 32 that are mutually communicated, the first groove section 31 is located between the outer wall of the cone 22 and the inner wall of the connecting end 11, and the second groove section 32 is located between the outer wall of the cylinder 23 and the inner wall of the connecting end 11.

By adopting this scheme, the first groove section 31 is disposed between the outer wall of the cone 22 and the inner wall of the connecting end 11, and the second groove section 32 is disposed between the outer wall of the cylinder 23 and the inner wall of the connecting end 11, and the first groove section 31 and the second groove section 32 are mutually communicated, which can make the solder more easily penetrate into the first groove section 31 and the second groove section 32 during the welding of the outer wall of the cone 22, the outer wall of the cylinder 23, and the inner wall of the connecting end 11, and the welding groove 30 can be fully filled with the solder, thereby a problem that the solder could not be penetrated during the welding due to the close-fitting between the end cover 20 and the valve body 10 can be avoided. Herein, the disposition of the cone 22 of the end cover 20 can facilitate the solder to flow into the first groove section 31 and the second groove section 32 during the welding, and the welding quality and sealing effect between the end cover 20 and the valve body 10 are improved, thereby the valve body 10 is avoided from leaking.

Herein, the first groove section 31 can be separately disposed on the outer wall of the cone 22 or the inner wall of the connecting end 11, or the first groove section 31 is composed of a groove on the outer wall of the cone 22 and a groove on the inner wall of the connecting end 11 together. The second groove section 32 can be separately disposed on the outer wall of the cylinder 23 or the inner wall of the connecting end 11, or the second groove section 32 is composed of a groove on the outer wall of the cylinder 23 and a groove on the inner wall of the connecting end 11 together.

In some embodiments, one end of the first groove section 31 is communicated with an outside of the reversing valve. This disposition can facilitate the solder to smoothly flow into the first groove section 31 and the second groove section 32 during the welding of the end cover 20 and the valve body 10, and the welding quality is improved.

Optionally, a cross-section of the welding groove 30 can be rectangular, semi-circular and the like.

In some embodiments, the first groove section 31 is located on the outer wall of the cone 22, and the second groove section 32 is located on the outer wall of the cylinder 23. The first groove section 31 is disposed on the outer wall of the cone 22 and the second groove section 32 is disposed on the outer wall of the cylinder 23, which facilitates the processing and reduces costs.

In some embodiments, the first groove section 31 extends along a busbar on an outer surface of the cone 22, and the second groove section 32 extends along an axis of the cylinder 23. By adopting the above disposition, it is possible to effectively increase the length of the welding groove 30 during the welding between the end cover 20 and the connecting end 11, thereby more solders are allowed to penetrate between the end cover 20 and the connecting end 11, and the welding quality is improved.

In some embodiments, a length of the first groove section 31 is equal to a length of the busbar on the outer surface of the cone 22, or a length of the first groove section 31 is less than a length of the busbar on the outer surface of the cone 22. The length of the first groove section 31 can be equal to the length of the busbar on the outer surface of the cone 22, or can be less than the length of the busbar on the outer surface of the cone 22. The above disposition can achieve smooth penetration of the solder during the welding, thereby the welding quality between the end cover 20 and the valve body 10 is guaranteed.

In some embodiments, a length of the second groove section 32 is equal to an axial length of the cylinder 23, or a length of the second groove section 32 is less than an axial length of the cylinder 23. The length of the second groove section 32 can be equal to the axial length of the cylinder 23, or can be less than the axial length of the cylinder 23. The above disposition can achieve smooth penetration of the solder during the welding, thereby the welding quality between the end cover 20 and the valve body 10 is guaranteed.

In some embodiments, a groove depth of the welding groove 30 on a radial section of the welding groove 30 is 0.02 mm to 0.1 mm. The groove depth of the welding groove 30 on the radial section is set within the above range, which can not only guarantee the penetration amount of the solder during the welding, and meet the welding quality requirement, but also reduce the costs.

As shown in FIGS. 2 to 5, the inner wall of the connecting end 11 includes a cylindrical wall 111 and a conical wall 112 that are mutually connected, herein the cylindrical wall 111 is welded with the cylinder 23, and the conical wall 112 is welded with the cone 22.

The first groove section 31 is located on the conical wall 112, and the second groove section 32 is located on the cylindrical wall 111. In some embodiments, the connecting end 11 and the end cover 20 are firstly riveted and then welded, and the conical wall 112 is formed after being riveted. It is welded by disposing the first groove section 31 on the conical wall 112 and disposing the second groove section 32 on the cylindrical wall 111, which can improve the welding effect between the end cover 20 and the connecting end 11, and the welding quality is guaranteed.

Herein, the valve body 10 includes a main body and a connecting end 11, a wall thickness of the connecting end 11 is less than a wall thickness of the main body, and the cylinder 23 is abutted against the main body. The connecting end 11 includes an outer peripheral surface and a limiting surface. The limiting surface is stop matched with the end cover 20, so that when the end cover 20 and the connecting end 11 are assembled, the limiting surface can limit the insertion depth of the end cover 20. A part of the structure of the end cover 20 is located on the outside of the valve body 10, and the end cover 20 blocks an opening of the valve body 10.

In some embodiments, there is a plurality of the welding grooves 30, and the plurality of the welding grooves 30 is disposed along a circumferential direction of the end cover 20. By disposing the plurality of the welding grooves 30, the disposition of the solder can be more uniform, thereby the welding strength between the end cover 20 and the valve body 10 is enhanced, the sealing performance of the two is improved, and the leakage is prevented.

Herein, a connection portion between the outer wall of the cone 22 and the outer wall of the cylinder 23 has a chamfer, and the plurality of the welding grooves 30 is formed by a knurling structure. By disposing the chamfer at the connection portion between the outer wall of the cone 22 and the outer wall of the end cover 20, it is convenient for welding and assembly. The disposition of the knurling structure can reduce the processing costs.

In some embodiments, a size of the cover body 21 is less than a size of the cone 22 in a radial direction of the valve body 10; and a length of the connecting end 11 is greater than a total length of the cone 22 and the cylinder 23 in an axial direction of the valve body 10. By setting the size of the cover body 21 to be less than the size of the cone 22, it is convenient for the assembly of the end cover 20; and the length of the connecting end 11 is greater than the total length of the cone 22 and the cylinder 23, which can guarantee the effective length during the welding, and thus the welding quality is improved.

As shown in FIG. 1, there are two end covers 20 and two connecting ends 11. In some embodiments, the reversing valve is a four-way valve.

The four-way valve is located in a refrigerant circuit composed of an indoor heat exchanger and an outdoor heat exchanger and the like, usually including three parts: an electromagnetic coil, a main valve, and a pilot valve. Two ends of the valve body 10 of the main valve are both welded with the end covers 20, and there is a slider in the valve body 10. The slider is respectively connected with a left piston and a right piston by connecting rods, and the left piston and the right piston divide the cavity of the main valve into a left chamber, a middle chamber, and a right chamber; and an upper portion of the slider is machined with a step and is matched with the above connecting rods by the step, and a lower portion of the slider has an inner cavity. A group of connecting pipes passes through the inner cavity to form a closed fluid cycle, and the other group of connecting pipes passes through the inner cavity of the valve body 10 to form another closed fluid cycle. The paths of the two groups of the fluid cycles are separated by a main body portion of the slider. When an air conditioner needs refrigeration, under the action of the pilot valve, a pressure difference is formed between the left chamber and the right chamber of the main valve. The pressure difference between the left chamber and the right chamber of the main valve drives the slider and the two pistons to move, so that a refrigerant inside a system is flowed from a compressor exhaust port to a compressor suction port, and the system is in a refrigeration working state; and when the air conditioner needs heating, also under the action of the pilot valve, a pressure difference is formed between the left chamber and the right chamber of the main valve, this pressure difference drives the slider and the two pistons to move in opposite directions, so that the refrigerant is flowed to the compressor suction port, and the system is in a heating working state. By the above process, a purpose of dual use of one machine for cooling in summer and heating in winter is achieved.

The above are only preferred embodiments of the present disclosure and are not intended to limit the present disclosure. For those skilled in the art, the present disclosure can have various modifications and variations. Any modifications, equivalent replacements, improvements and the like made within the spirit and principles of the present disclosure shall be all contained within the scope of protection of the present disclosure.

What is claimed is:

1. A reversing valve, wherein the reversing valve comprises:
a valve body, wherein the valve body is a tubular structure, and an end portion of the valve body is a connecting end;
an end cover, wherein the end cover comprises a cover body, a cone, and a cylinder, an end with a small outer diameter of the cone is connected with the cover body, an end with a large outer diameter of the cone is connected with the cylinder, both the cone and the cylinder are inserted into the connecting end, and an outer wall of the cone and an outer wall of the cylinder are both welded with an inner wall of the connecting end; and
a welding groove, wherein the welding groove is used for filling a solder, the welding groove comprises a first groove section and a second groove section that are mutually communicated, the first groove section is located between the outer wall of the cone and the inner wall of the connecting end, and the second groove section is located between the outer wall of the cylinder and the inner wall of the connecting end.

2. The reversing valve as claimed in claim 1, wherein the first groove section is located on the outer wall of the cone; or the second groove section is located on the outer wall of the cylinder; or the first groove section is located on the outer wall of the cone, the second groove section is located on the outer wall of the cylinder.

3. The reversing valve as claimed in claim 1, wherein the first groove section extends along a busbar on an outer surface of the cone, and the second groove section extends along an axis of the cylinder.

4. The reversing valve as claimed in claim 1, wherein a length of the first groove section is equal to a length of the busbar on the outer surface of the cone, or a length of the first groove section is less than a length of the busbar on the outer surface of the cone.

5. The reversing valve as claimed in claim 1, wherein a length of the second groove section is equal to an axial length of the cylinder, or a length of the second groove section is less than an axial length of the cylinder.

6. The reversing valve as claimed in claim 1, wherein a groove depth of the welding groove on a radial section of the welding groove is 0.02 mm to 0.1 mm.

7. The reversing valve as claimed in claim 1, wherein the inner wall of the connecting end comprises a cylindrical wall and a conical wall that are mutually connected, wherein the cylindrical wall is welded with the cylinder, and the conical wall is welded with the cone.

8. The reversing valve as claimed in claim 7, wherein the first groove section is located on the conical wall; or the second groove section is located on the cylindrical wall; or the first groove section is located on the conical wall, the second groove section is located on the cylindrical wall.

9. The reversing valve as claimed in claim 1, wherein there is a plurality of the welding grooves, and the plurality of the welding grooves is disposed along a circumferential direction of the end cover.

10. The reversing valve as claimed in claim 9, wherein a connection portion between the outer wall of the cone and the outer wall of the cylinder has a chamfer, and the plurality of the welding grooves is formed by a knurling structure.

11. The reversing valve as claimed in claim 1, wherein a size of the cover body is less than a size of the cone in a radial direction of the valve body; and a length of the connecting end is greater than a total length of the cone and the cylinder in an axial direction of the valve body.

12. The reversing valve as claimed in claim 1, wherein one end of the first groove section is communicated with an outside of the reversing valve.

13. The reversing valve as claimed in claim 1, wherein a cross-section of the welding groove is rectangular or semi-circular.

14. The reversing valve as claimed in claim 1, wherein the valve body comprises a main body and the connecting end, a wall thickness of the connecting end is less than a wall thickness of the main body, the cylinder is abutted against the main body.

15. The reversing valve as claimed in claim 14, wherein the connecting end comprises an outer peripheral surface and a limiting surface, the limiting surface is stop matched with the end cover.

16. The reversing valve as claimed in claim 1, wherein there are two end covers and two connecting ends.

17. The reversing valve as claimed in claim 1, wherein the reversing valve is a four-way valve.
